(19) United States
(12) Patent Application Publication
(10) Pub. No.: US 2009/0063501 A1
(43) Pub. Date: Mar. 5, 2009

(54) SYSTEMS, METHODS AND COMPUTER PRODUCTS FOR GENERATING POLICY BASED FAIL OVER CONFIGURATION FOR DARABASE CLUSTERS

(75) Inventors: Andrew D. Buckler, Markham (CA); Dale M. Mcinnis, Aurora (CA); Subho Chatterjee, North York (CA); Steve Raspudic, Mississauga (CA); Anand Subramanian, Markham (CA)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/849,021

(22) Filed: Aug. 31, 2007

(51) Int. Cl. G06F 17/30

(52) U.S. Cl. 707/10; 707/E17.001

(57) ABSTRACT

Generating a plurality of database cluster failover policy availability configuration modeling solutions by a database cluster management system in an environment of networked computer systems includes receiving a first signal from a user system specifying one of a plurality of database cluster failover policy type behavior patterns. The database cluster management system determines whether generating any of the failover policy type behavior patterns requires additional supplemental data. If no supplemental data are required, then the database cluster management system generates general database cluster policy solutions. If supplemental data are required, then the system utilizes an algorithm to generate unique, specific policy solutions by creating failover node sequences for each of the plurality of failover policy type behavior patterns requiring such additional supplemental data. The entire solutions can be displayed and then transmitted to multiple database cluster managers over a network to correct availability failure in networked database cluster configurations.

### CROSS-REFERENCE TO RELATED APPLICATIONS

This application contains subject matter which is related to the subject matter of the following co-pending applications, each of which is assigned to the same assignee as this application, International Business Machines Corporation of Armonk, N.Y. Each of the below listed application(s) is hereby incorporated herein by reference in its entirety: U.S. patent application Ser. No. 11/848,783.

### TRADEMARKS

IBM® is a registered trademark of the International Business Machines Corporation, Armonk, N.Y., U.S.A. Other names used herein may be trademarks and registered trademarks, or trade or product names of International Business Machines Corporation or other companies.

### TECHNICAL FIELD

The exemplary embodiments relate generally to networked computer system administration and management, relating to storage management, by generating database cluster configuration data modeling solutions for database cluster requirements. More particularly, the exemplary embodiments relate to management of failover policy for configuration of database clusters, by automatically generating parts of a data model. The exemplary embodiments can be applied to any system running any service provider application.

### BACKGROUND

In general, clusters are groups of computer systems, which can provide advantages in access availability (service uptime) through redundant hardware. For example, if systems A and B are in a cluster together and system A fails, then its workload can be relocated to system B. In clusters that involve more systems (or “nodes” in cluster parlance), the specification of the workload relocation can be more complex; therefore, the specification of the full configuration of a cluster and DB2 instances contained within it renders policy configuration management both error prone and time consuming, given the large amount of data which must be specified. Clusters manage “resource groups”, which are taken to be a collection of resources (hardware or software) that provide a service to clients and can be treated as a unit. Each resource group can then have its own relocation specification, so that resource group A can use nodes A, B, and C in priority sequence and resource group B can use A, C, and B. Thus, groups A and B will start on node A, but upon failure will move to different nodes. This relocation sequence, which is termed a “failover node sequence” in this document, is a fundamental aspect of cluster configuration. Improperly setting up the failover node sequence based on faulty high-level policy specification configuration can have a variety of ill effects. Resource groups can have limited redundancy if they are not configured to failover to some nodes in the system that could support their operation. Or, groups can all be directed to the same node on failure, which could lead to resource scarcity (memory or CPU) on that node and lead to a degradation of perceived cluster performance. Compounding the difficulties with correctly specifying failover node sequences is the fact that large clusters, such as those in data warehouses, can use many resource groups. Production systems in real world data warehouse clusters currently have in the neighborhood of 40 resource groups, as each DB2 partition is managed in a separate group. Thus, the failover node sequence must be specified 40 times. Scripting may be used to automate this process, but it is still error prone. Also, as the cluster grows each of the groups may have to have its failover node sequence updated manually to take advantage of the new node. Another issue that complicates manual configuration is that data warehouses increasingly deal with databases that have different classes of partitions tailored to specific functionalities. For example, the standard DB2 data warehousing configuration (called the Data Warehousing Balanced Configuration Unit (BCU)), has different hardware and software settings for the administration nodes to which users connect compared to the data nodes that do the bulk of the database processing. Typically these sets of partitions would use disjoint sets of hardware to support their operation, and so their failover node sequences would not overlap. Manual configuration requires the user to first recall or look up which nodes and partitions fall into which class of operation, which is yet another error prone step. Additionally, most database administrators are not familiar with clustering or its associated terminology, which creates usability issues when databases must be clustered. These problems have been observed in general in many types of service provider networked database cluster applications. Thus, problems with configuring networked database clusters for high availability solutions are not limited to the above mentioned applications. Other applications and vendors are similarly affected.

Therefore, the need exists for a failover policy configuration management system that can specify failover behavior in very concise terms for complex specifications of workload relocation, thus providing a reduction in work and error rates, given the large amount of data, which must be specified.

Further, the need exists for a failover policy configuration management system that can automate the process of configuring failover behavior within a DB2 cluster by allowing the user to select a high-level policy that conforms with their configuration, then translating the user's high-level statement of desired behavior onto the detailed behavior for each partition, thereby maintaining the policy information as persistent at a high-level, which can allow new cluster nodes and/or new DB2 partitions to have their behavior specified with no user input at all; thus, reducing the impact of improper failover node sequence management.

Further, the need exists for a failover policy configuration management system, where high-level policy information can be accessed by the cluster model systems where the user specifies the configuration of a clustered database instance in terms of familiar hardware (node/system, network interface network) and database (instance database, path) objects contained in a unified model, which provides a complete specification of the cluster configuration. This permits the specification of policy to be included in the end-to-end analyses and configurations verification processes.

Finally, the need exists for a failover policy configuration management system and method that can be easily migrated to a new behavior, in regard to version-to-version migrations of DB2, which can require different specifications to the underlying cluster manager, as well as simplifying cluster manager-to-cluster-manager migrations, as the customer moves to more flexible underlying hardware/storage technologies, or as more advanced failover behaviors become supported by DB2, because most database administrators are not familiar with clustering or its associated terminology, which creates usability issues when databases must be clustered and because change management is a large painpoint for clustered databases, thus automating the migration provides significant value to the user.

### SUMMARY OF THE INVENTION

A method and system of generating one of a plurality of database cluster failover policy availability configuration modeling solutions by a database cluster management system in an environment of networked computer systems includes receiving a first signal from a user system specifying one of a plurality of database cluster failover policy type behavior patterns. The database cluster management method and system determine whether generating any of the failover policy type behavior patterns require additional supplemental data. If supplementary data are not required then the policy behavior specification alone is sufficient to produce a unique solution, where a solution is comprised of the set of failover node sequences for DB2 partitions in the cluster, wherein each DB2 partition is associated with a single failover node sequence. If supplementary data are required then the policy behavior alone could be satisfied by multiple solutions. In this case the system utilizes an algorithm to automatically generate a single unique solution for the given policy behavior by combining the supplemental data with specific policy. This algorithm selects the single unique solution that conforms to the supplemental data from the multiple solutions which would satisfy the policy behavior specification alone. The algorithm therefore allows creating failover node sequences for each of the plurality of failover policy type behavior patterns requiring such additional supplemental data. Regardless of whether supplemental data are required, the entirety of the unique solution that results from the previously described processing can be displayed and then transmitted to multiple cluster managers over a network to correct availability failure in networked database cluster configurations, wherein in any single cluster only one cluster manager will be active. The plurality of failover policy type behavior patterns includes a round robin policy type behavior pattern, a mutual policy type behavior pattern, an idle policy type behavior pattern, a distributed policy type behavior pattern and a custom policy type behavior pattern. When the database cluster management method and system determine that the failover policy type behavior patterns, from the plurality of failover policy type behavior patterns, require no supplemental data set for generating the database cluster failover configuration modeling solution, the database cluster management method and system perform a first group of sub operations, which include identifying a set of disjoint sub clusters, by matching partition and node type tags; validating that a number of nodes in each sub cluster of the set of disjoint sub clusters meet requirements of a given failover policy type behavior pattern and meet requirements of the group of supplemental data sets; furthermore, when the group of supplemental data sets is required; the unique policy solution is generated by the second group of sub operations in order to specify a failover node sequence for each partition, where the second group of sub operations combine the failover policy type behavior patterns with a group of supplemental data sets. Thus, rather than specifying the failover behavior for each partition, the user specifies the pattern which failover behaviors should follow and some small set of supplemental information that allows the system to generate a unique solution that implements the desired behaviors. Furthermore, the database cluster management system receives a second signal, from the user system, specifying the group of supplemental data sets and the group of supplemental data sets includes a data set defining partition and node types, a data set defining a number of nodes, a data set defining storage topology, a data set defining desired behavior policy types and a data set defining supplemental information. Further, in combining the failover policy type behavior patterns with a group of supplemental data sets includes a third group of sub operations comprising creating the failover node sequence specified from the plurality of failover policy type behavior patterns using an algorithm that acts on each sub cluster independently. For configuration of the round robin policy type behavior pattern, the algorithm retrieves a list of nodes for each sub cluster in arbitrary order; and sets an i-th node's resource groups to fail to nodes ((i+1) mod X, (i+2) mod X . . . (i+(X-1)) mod X) in sequence. For configuration of the mutual policy type behavior pattern, the algorithm sets each resource group of a plurality of resource groups on a first node to fail to a second node, and the second node to fail to the first node. For configuration of the idle policy type behavior pattern, the algorithm performs the sup operation of retrieving a list of active nodes for the sub cluster in arbitrary order; retrieves a list of idle nodes for the sub cluster in arbitrary order, where there are S number of nodes in a zero-indexed list; and then the algorithm sets each resource group from the plurality of resource groups on the i-th active node fail to idle nodes (i mod X,(i+1) mod X . . . (i+(X-1)) mod X) in sequence. For configuration of the custom policy type behavior pattern, the supplemental data set for the sub cluster fully specifies the failover node sequences and configuration of custom policy type behavior patterns sub operations are equivalent to configuration of manual policy type behavior patterns, where configuration of manual policy type behavior patterns requires the user to first either recall or look up which nodes and which partitions fall into a class of operation. Furthermore, by this stage there is only “the unique policy solution” and the database cluster management method and system displays the unique policy solution as the entire database cluster configuration modeling solution; and transmits the entire unique policy solution over the network to multiple database cluster managers to correct availability failure in database cluster configurations. For example, specifying “mutual” behavior alone does not guarantee a unique solution, because numerous pairs of systems could be selected and each arrangement of pairs produces a different solution. But if the pairs are specified as part of the supplementary data set then only one set of failover node sequences can be specified that conforms to the given set of pairs. Further, the plurality of failover policy type behavior patterns can be restricted, when an interactive configuration graphical user interface is used to implement the receipt of the first signal from the user system specifying one of a plurality of failover policy type behavior patterns. Furthermore, the database cluster management method and system automatically generates an update unique policy solution by overwriting any failover node sequences that changed, when a new node is added to the cluster. In addition, weights can be added for each partition's resource group when a number of resource groups on a node exceeds a number of nodes available to host each partition's resource group after failover, wherein the failover node sequence is changed to equalize the sum of the weights of resource groups that are sent to each other node.

### BRIEF DESCRIPTION OF THE DRAWINGS

The subject matter that is regarded as the exemplary embodiments are particularly pointed out and distinctly claimed in the claims at the conclusion of the specification. The foregoing and other objects, features, and advantages of the exemplary embodiments are apparent from the following detailed description taken in conjunction with the accompanying drawings, which are meant to be exemplary, and not limiting, wherein:

FIG. 1 illustrates operations of a database cluster failover policy configuration modeling method.

FIG. 2 illustrates the system implementing operations of the method illustrated in FIG. 1.

### DETAILED DESCRIPTION

Exemplary embodiments of the method and system for generating and mapping a plurality of database cluster failover policy availability configuration modeling solutions to a customer and/or user's database cluster manager software applications are described in detail below. The disclosed exemplary embodiments are intended to be illustrative only, since numerous modifications and variations therein will be apparent to those of ordinary skill in the art. In reference to the drawings, like numbers will indicate like parts continuously throughout the view. The exemplary embodiments disclosed herein address problems in service uptime availability of groups of computer systems including database operations (referred to herein as “database clusters”). However, the disclosed exemplary embodiments can be applied to any system running any service provider application. Further, the terms “a”, “an”, “first”, “second” and “third” herein do not denote limitations of quantity, but rather denote the presence of one or more of the referenced item(s).

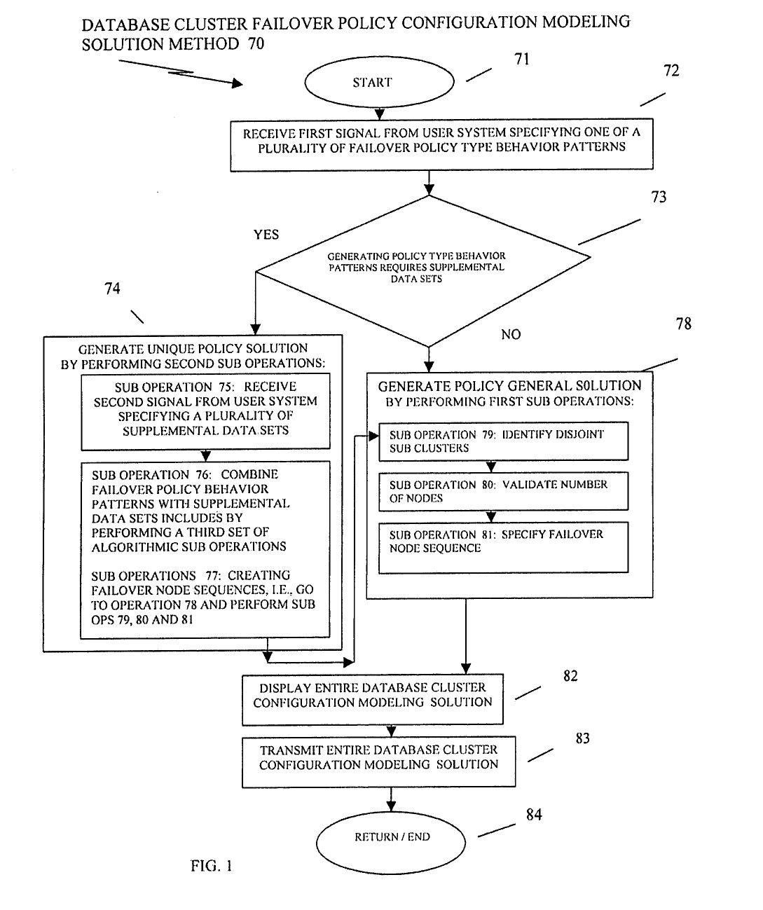

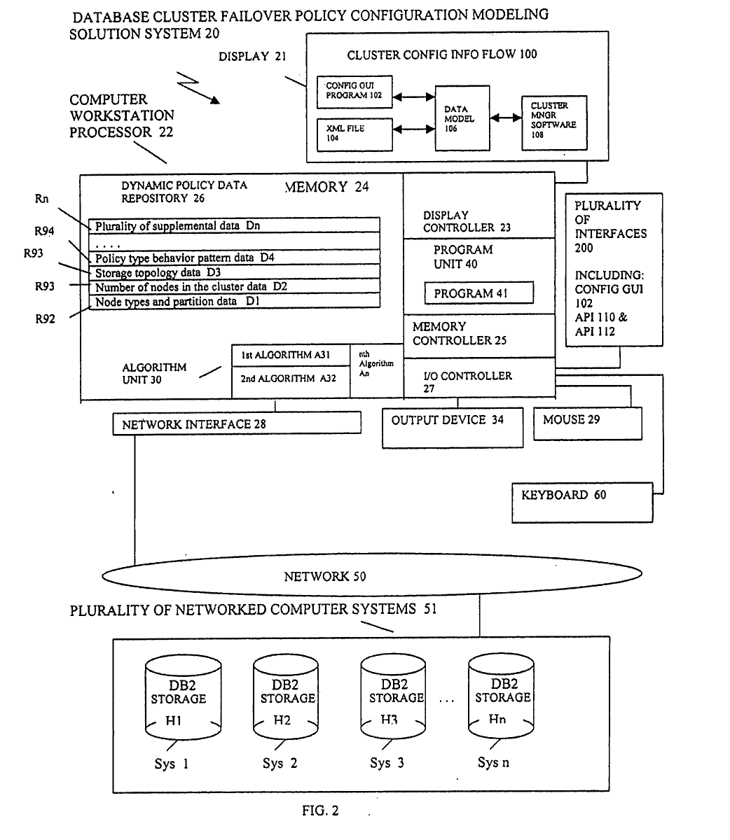

A database cluster failover policy configuration modeling method 70 (herein referred to as “method 70”) and a database cluster failover policy configuration modeling system 20 (herein referred to as “system 20”), implementing method 70, are illustrated in FIG. 1 and FIG. 2.

Referring to FIG. 2, and Table 2, system 20 includes computer workstation processor 22, which contains memory 24. Algorithm unit 30 resides in memory 24 and contains a plurality of algorithms including first algorithm A31 and second algorithm A32 up to nth algorithm An. Also, residing in system 20 is program unit 40, containing program 41. Memory 24 also contains a dynamic policy data repository 26, which contains a plurality of repository entry locations R91, R92, R93, and R4 up to Rn, which stores cluster policy data persistently, including node types and partition data D1, number of nodes in a cluster data D2, storage topology data D3, and policy type behavior pattern data D4 up to a plurality of supplemental data Dn respectively, including unified modeling language (UML) diagram data, which represents the logical data configurations in Table 1 and the data composing the content and structural form of data model 106 displayed on display 21 as part of the overall cluster configuration information flow 100 illustrated in FIG. 2. Dynamic policy data repository 26 can be actual or virtual memory either on-board or external to computer workstation processor 22. While the concrete specification of failover node sequences can be quite involved, the actual data involved is highly repetitious and tends to follow clear patterns of behavior. Thus, by asking the user for this behavioral pattern data, and potentially some additional information, i.e., supplemental data Dn to provide specific details, the system can reduce the amount of configuration that needs the user's direct input. Therefore, by storing the policy data persistently in dynamic policy data repository 26, system 20 can automatically handle the addition and removal of nodes from the cluster without additional user interaction.

In the exemplary embodiment, computer workstation processor 22 includes a combination of controllers including display controller 23, memory controller 25 and input/output (I/O) controller 27, a plurality of interfaces 200 including interfaces cooperatively connected and implemented by either software and/or hardware to a database cluster configuration graphical user interface program 102 (herein referred to as “config GUI program 102”) implemented by either software and/or hardware and a set of application programming interfaces (herein referred to as “API 110 and API 112”) implemented by either software and/or hardware and a combination of computer peripheral devices cooperatively coupled to system 20 including display 21, a set of input devices including keyboard 60 and mouse 29, network interface 28, and output device 34, via standard interface connectivity. Network interface 28 cooperatively couples computer workstation processor 22 via network 50 (where network 50 can be a wide area network such as the Internet or a local area network, including an intranet or an extranet) to a plurality of networked computer systems 51 including a plurality of DB2 database storage devices H1, H2, H3 up to Hn in a cluster configuration physically, virtually or logically implemented as a plurality of systemson network 50, including sys 1, sys 2, sys 3 up to sys n for data storage and retrieval operations.

Display 21 can render displays of the following: a graphical images and/or text representing UML diagrams, database cluster configuration modeling specifications solutions, including data model 106 from cluster config info flow 100 displayed by display 21 in FIG. 2. which represents solutions for multiple DB2 storage sites. Cluster config info flow 100 graph includes, contained in data model 106, specified objects and paths providing a definition of a database cluster configuration model, where the objects include nodes, networks, network interfaces and paths, expressed through logical symbolic representations. Display 21 can also display graphical images and text representing the contents of all or a subset of the contents of data model 106. In the exemplary embodiment, display 21 can display the policy data stored in dynamic policy data repository 26; Table 1 represents, the policy data stored in dynamic policy data repository 26:

TABLE 1
Policy Type Behavior Data

| | Cardinality | Storage Topology | | |
|---|---|---|---|---|
| Policy Type | Restriction | Requirement | Description | Required Data |
| Round Robin | None | Fully connected | Given nodes A, B, and C. | None |
| | | storage within a | All host RGs. | |
| | | node type. | All RGs from A move to B. | |
| | | | All RGs from B move to C. | |
| | | | All RGs from C move to A. | |
| | | | Note: Reduces to | |
| | | | Active/Active in the 2 node | |
| | | | case. However, even with 2 | |
| | | | nodes RR should be a distinct | |
| | | | option as it provides a | |
| | | | different growth path from the | |
| | | | A/A policy. | |
| Mutual | N mod 2 = 0 | Pairwise connected | Given a pair of nodes A and | Pair definitions. |
| | | storage. | B. | |
| | | | RGs move from A to B. | |
| | | | RGs move from B to A. | |
| M Idle Nodes | N > 2 | Idle nodes fully | Given N + M nodes. | Idle nodes. |
| (Some number of | | connected. | N host RGs, M nodes idle. | |
| nodes, M, is kept | | | RGs move from any hosting | |
| fully idle to | | | node to any idle node. | |
| handle failover) | | | | |
| Distributed | None | Fully connected | Given N nodes. | None |
| | | storage within a | Each hosts X RGs. | |
| | | node type. | Each surviving node hosts | |
| | | | N/X RGs after failure. | |
| Custom | None | Topology must not | Any configuration not | Full failover |
| | | contradict given | precluded by storage topology | node sequences |
| | | failover node | can be defined, | for all partitions. |
| | | sequences. | | |

The unified model language diagram of a model database cluster instance configuration definition is shown in part below in TABLE 2. The UML diagram is a visual representation of the logical structure of the data model 106 that the service provider has built as a model for database cluster uptime availability solutions. The “Partition” box in Table 2, an “Instance” box, which indicates that the Partition in the UML diagram is a child of the Instance. The multiplicities on these connections indicate the Instance may be the parent of N Partitions. The data listed within the Partition box indicates that the set of information that each Partition of that type in tie network contains. The complete set of such nodes and their interconnections form data model 106 the database cluster configuration model that is built from the combination of the existing database cluster configuration data (pulled from the cluster manager software 108) and/or the XML file 104 and/or the user input from the interactive configuration GUI program 102, all illustrated as part of the database cluster configuration information flow 100 displayed by display 21 in FIG. 2.

TABLE 2
Partial Unified Model Diagram of Database Cluster Instance Configuration Definition of
Parent Child Relationships

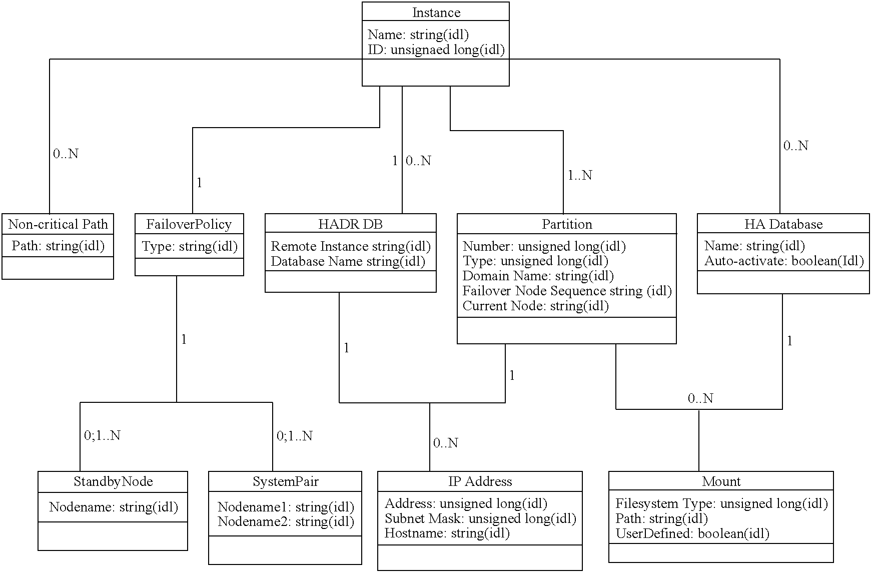

In addition to the Partition and instance boxes, Standby Node, System Pair and Failover Policy boxes are also represented in Table 2. Method 70 and system 20 can rapidly specify Failover Policy, Standby Node and SystemPair, along with Partition, failover node sequences configuration throughout the cluster, even when the cluster contains hundreds of partitions and twenty to thirty nodes. So, instead of individually, manually configuring the hundreds of partitions and many nodes, the user specifies at a high level the failover policy in the model and a standby node under the failover policy or system pair under that failover policy and system 20 uses that information to harvest information from the cluster and generate failover node sequences automatically for portions of the data model 106.

Referring to FIG. 1 and FIG. 2, at operation start 71 of method 70, an operator/user, using an input device such as any one of input devices mouse 29 or keyboard 60, activates and initiates program 41, where method 70 is stored as executable program code on a computer executable medium. The operator/user activates program 41 and performs other selections in method 70 by making entries using keyboard 60 or mouse 29; thus, causing program 41 to be executed by computer workstation processor 22 to perform the operations of method 70, thereby including generating, by a database cluster failover policy configuration modeling system 70, a plurality of database cluster failover policy availability configuration modeling solutions for the plurality of networked computer systems 51.

At operation receive first signal from user system specifying one of a plurality of failover policy type behavior patterns 72 (herein referred to as “operation 72”), program 41 when executed by computer workstation processor 22, causes computer workstation processor 22 to receive a first signal from a set of user input devices, including mouse 29 and keyboard 60 or an interface including configuration graphical user interface program 102 (herein referred to as “config GUI program 102”) and/or any one or more of a set of application programming interfaces API 110 and API 112 specifying one of a plurality of failover policy type behavior patterns causing the database cluster failover policy configuration modeling solution system 20 (which is a computer automated database cluster management system) to provide a plurality of database cluster failover policy availability configuration modeling solutions, such as data model 106 illustrated in FIG. 2 as part of cluster config info flow 100 graph displayed by display 21, where data model 106 is the configuration model for providing solutions for database cluster availability requirements in the plurality of networked computer systems 51. Further, the config GUI program 102 can be an interactive configuration graphical user interface, wherein the plurality of failover policy type behavior patterns are restricted when the interactive configuration graphical user interface program 102 is actuated and provides the first signal received from the user system specifying one of a plurality of failover policy type behavior patterns. The plurality of failover policy type behavior patterns includes a round robin policy type behavior pattern, a mutual policy type behavior pattern, an idle policy type behavior pattern, a distributed policy type behavior pattern and a custom policy type behavior pattern. These policy type behavior patterns are items of policy data represented in Table 1 above and are stored in dynamic policy data repository 26 in repository entry location R4 as policy type behavior pattern data D4. In the exemplary embodiments, policy type behavior patterns can be either written into a routine in program 41 and/or loaded into the dynamic data model definition repository 26, so that the process of specifying failover policy node sequences for building data model 106 can be dynamic and enforced programmatically and then accessed programmatically through a routine or an algorithm called by program 41 or through an application programming interface call from API 110 and/or API 112. Further, the computer executable program when executed by the computer workstation processor 22 causes system 20 to automatically generate an update unique policy solution by overwriting any failover node sequences that change state, when a new node is added to the cluster. Thus, the user selects a high-level policy that conforms with the user's desired configuration, based on desired policy type behavior patterns, then computer workstation processor 22 translates the user's high-level statement of desired policy type behavior patterns onto the detailed behavior for each partition, thereby maintaining the policy information as persistent at a high-level, which can allow new cluster nodes and/or new DB2 partitions to have their behavior specified with minimal to no user input at all; thus, reducing the impact of improper failover node sequence management such as limited redundancy and memory resource scarcity by abstracting the user from the configuration details. Rather than specifying the failover policy type behavior pattern for each partition, the user specifies the policy type behavior pattern, which the failover behaviors should follow and some small set of supplemental information that allows system 20 to generate a unique solution that implements the desired policy type behavior patterns. Further, automating the process of configuring failover behavior provides the ability to switch the failover policy in one step and have the results reflected cluster-wide.

At operation generating policy type behavior patterns requires supplemental data sets 73 (herein referred to as “operation 73”), program 41 when executed by computer workstation processor 22, further causes computer workstation processor 22 to determine whether a failover policy type behavior pattern from the plurality of failover policy type behavior patterns received in the first signal requires a group of supplemental data sets for generating the database cluster failover configuration modeling solution. If supplementary data are required then the policy behavior alone could be satisfied by multiple solutions. In this case, the system utilizes an algorithm to automatically generate a single unique solution for the given policy behavior by combining the supplemental data with the currently selected policy, where this currently selected policy is chosen from a plurality of possible policy types. This algorithm selects the single unique solution that conforms to the supplemental data from the multiple solutions which would satisfy the policy behavior specification alone.

At operation generate one unique policy solution 78 (herein referred to as “operation 78”), program 41 when executed by computer workstation processor 22, further causes system 20 to generate a unique policy solution by performing a first group of sub operations including sub operation 79, sub operation 80, sub operation 85 and sub operation 81, when the database cluster management system determines that the failover policy type behavior pattern, from the plurality of failover policy type behavior patterns, requires no supplemental data set for generating the database cluster failover configuration modeling solution, i. e., “generating policy type behavior patterns requires supplemental data sets (NO).

At sub operation 79: identify disjoint sub clusters, program 41 when executed by computer workstation processor 22, further causes system 20 to identify a set of disjoint sub clusters, by matching partition and node type tags, where the node tag types can be specified using any of a plurality of markup languages including Extensible Markup language (XML) tags, but once the tag types are in data model 106, it doesn't matter how they were initially read into the model.

At sub operation 80: validate number of nodes, program 41 when executed by computer workstation processor 22, further causes computer workstation processor 22 to validate that a number of nodes in each sub cluster of the set of disjoint sub clusters meets requirements of a given failover policy type behavior pattern (and meets requirements of the group of supplemental data sets, when the group of supplemental data sets is required) all of which are data represented in Table 1 above and all of which can be stored in dynamic policy data repository 26.

Storage topology constraint checks can be performed, even if the policy behavior type does not require supplemental data. For example, the distributed failure policy can require no supplemental data, but it does require fully connected storage. Another sub operation (i.e., sub operation 85) of the first sub operations can be included between sub operations 80 and 81, where sub operation 85 performs storage topology verification, if storage topology data is provided to the system; however, sometimes storage topology data is not always provided.

At sub operation 85: verify storage topology, program 41 when executed by computer workstation processor 22, further causes computer workstation processor 22 to verify that storage is connected so that partitions can access data from storage, where the storage is connected fully and/or pairwise and so that the storage topology does not contradict given failover node sequences.

At sub operation 81: specify failover node sequence, program 41 when executed by computer workstation processor 22 in system 20, further causes computer workstation processor 22 to specify a failover node sequence, for each partition. Thus, the overall cluster is divided into multiple disjoint sub clusters for the purpose of defining failover node sequences. In the exemplary embodiments, the computer executable program code of program 41 when executed by the computer workstation processor 22 can cause system 20 to add weighted values, when creating failover node sequences for the distributed failover policy behavior patterns, to each partition's resource group when a number of resource groups on a node exceeds a number of nodes available to host each partition's resource group after failover, and wherein the failover node sequence changes state to equalize the sum of the weights of resource groups that are sent to each other node.

At operation generate multiple unique policy solutions 74, program 41 when executed by computer workstation processor 22, further causes computer workstation processor 22 to perform a second group of sub operations including sub operation 75, sub operation 76 and sub operation 77. In the exemplary embodiments, After completing sub operation 77, program 41 when executed by computer workstation processor 22, can further cause computer workstation processor 22 to repeat the performing of the first sub operations, in conjunction with supplemental data.

At sub operation 75, program 41 when executed by system 20, further causes system 20 to receive a second signal, from the user system, specifying the group of supplemental data sets, where the group of supplemental data sets includes a data set defining partition and node types data D1 stored in repository entry location R92 of dynamic policy data repository 26, a data set defining a number of nodes in the cluster, i.e., data D2, a data set defining storage topology (Storage topology provides natural constraints on failover behavior for database partitioning feature (DPF) databases, as partitions can only move to nodes that can access their data; when storage topology data is provided then the system can take it into account to ensure that the configuration produced is valid), i.e., data D3, a data set defining desired behavior policy type behavior pattern, i.e., data D4 and a data set defining supplemental information, i.e., up to Dn, all stored in dynamic policy data repository 26.

Sub operation 76 combines failover policy type behavior patterns with a group of supplemental data sets, when generating the failover policy type behavior patterns, from the plurality of failover policy type behavior patterns, requires the group of supplemental data sets. When system 20 combines the failover policy type behavior patterns with a group of supplemental data sets, a third group of sub operations, i.e., sub operations 77 implemented by program 41 when executed by system 20, further causes system 20 to call one or more of first algorithm A31 and/or second algorithm A32 up to nth algorithm An to operate within system 20 to create the failover node sequence specified from the plurality of failover policy type behavior patterns using an algorithm that acts on each sub cluster independently. The set of third Sub operations 77 include:

For configuration of the round robin policy type behavior pattern, one or more of first algorithm A31 and/or second algorithm A32 up to nth algorithm An operate to retrieve a list of nodes for each sub cluster in arbitrary order; and setting an i-th node's resource groups to fail to nodes ((i+1) mod X, (i+2) mod X . . . (i+(X-1)) mod X) in sequence.

For configuration of the mutual policy type behavior pattern, one or more of first algorithm A31 and/or second algorithm A32 up to nth algorithm An operate to set each resource group of a plurality of resource groups on a first node to fail to a second node, and the second node to fail to the first node.

For configuration of the idle policy type behavior pattern, one or more of first algorithm A31 and/or second algorithm A32 up to nth algorithm An operate to retrieve a list of active nodes for the sub cluster in arbitrary order; retrieve a list of idle nodes for the sub cluster in arbitrary order, wherein there are S number of nodes in a zero-indexed list; and set each resource group from the plurality of resource groups on the i-th active node fail to idle nodes (i mod X,(i+1) mod X . . . (i+(X-1)) mod X) in sequence.

For configuration of the distributed policy type behavior pattern, one or more of first algorithm A31 and/or second algorithm A32 up to nth algorithm An operate to retrieve the list of nodes in the sub cluster in arbitrary order, wherein there are X nodes in a zero-indexed list; and set the i-th partition's resource group to fail to nodes (i mod X, (i+1) mod X, (i+(X-1)) mod X) in sequence.

For configuration of the custom policy type behavior pattern, the supplemental data, up to Dn which can be stored in dynamic policy data repository 26, for the sub cluster fully specifies the failover node sequences, where configurations of custom policy type behavior patterns sub operations are equivalent to configuration of manual policy type behavior patterns, wherein configuration of manual policy type behavior patterns requires the user to first perform a recall operation or a look up operation of which nodes and which partitions fall into a class of operation.

Referring to FIGS. 1 and 2, after one or more of operation 74 and its sub operations 75, 76 and 77, as well as operation 78 and its sub operations 79, 80 and 81 have run, at operation 82, program 41, executed by computer workstation processor 22, causes computer workstation processor 22 to perform the operations of displaying on display 21 the entire database cluster configuration modeling solution at operation display entire database cluster configuration modeling solution 82 (herein referred to as “operation 82”). In the exemplary embodiment, any and all stages, operations and sub operations of method 70 can be displayed on display 21 for editing, programming and system management purposes, thereby, providing customers and users a way to visualize what their data is actually doing at any given time, when copying data to storage devices configured as a plurality of networked computer devices 51.

Referring to FIG. 1 and FIG. 2, thus after generating one or more of the entire multiple unique policy solutions and the one entire unique policy solution by at least one or more of operations 78 and 74, program 41, executed by computer workstation processor 22, causes computer workstation processor 22 to transmit, over the network, one or more of the entire multiple policy solution and the one entire unique policy solution to multiple database cluster managers to correct availability failure in database cluster configurations.

Referring to FIGS. 1 and 2, at operation return/end 84, method 70 can be directed by program 41 to return to any of the above operations and/or sub operations to continue iteratively processing and performing said operations and sub operations for a plurality of database cluster failover policy configuration modeling solutions, for example, in the exemplary embodiments, after completing sub operation 77, program 41 when executed by computer workstation processor 22, can further cause computer workstation processor 22 to repeat the performing of the first sub operations, i.e., sub operations 79, 80, 85 and 81, in conjunction with supplemental data or when there are no other requirements or requests to determine solutions, then program 41 can direct method 70 to end.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular exemplary embodiment disclosed as the best mode contemplated for carrying out this disclosure, but that the disclosure will include all embodiments falling within the scope of the appended claims.

What is claimed is:

1. A method of generating, by a database cluster management computer system, a plurality of database cluster failover policy availability configuration modeling solutions in a network of a plurality of computer systems, the method comprising:
receiving a first signal from a user computer system specifying one of a plurality of failover policy type behavior patterns causing the database cluster management computer system to provide a plurality of database cluster failover policy availability configuration modeling solutions solving database cluster availability requirements in the network of the plurality of computer systems, wherein the plurality of failover policy type behavior patterns includes a round robin policy type behavior pattern, a mutual policy type behavior pattern, an idle policy type behavior pattern, a distributed policy type behavior pattern and a custom policy type behavior pattern; and
determining one of whether generating policy type behavior patterns requires supplemental data sets and whether generating policy type behavior patterns requires no supplemental data sets; wherein, when generating policy type behavior patterns requires no supplemental data sets, then generating one unique policy solution including performing a first set of sub operations, displaying an entire database cluster configuration modeling solution for the policy general solution, transmitting the entire database cluster configuration modeling solution for the policy general solution, and performing one of returning and ending; wherein generating policy type behavior patterns requires supplemental data sets, then generating a unique policy solution including performing a second set of sub operations, returning to the operation of generating the policy general solution including performing the first set of sub operations, displaying the entire database cluster configuration modeling solution for the unique policy solution, transmitting the entire database cluster configuration modeling solution for the unique policy solution, and performing one of returning and ending; wherein the first set of sub operations includes identifying a set of disjoint sub clusters by matching partition and node type tags; validating that a number of nodes in each sub cluster of the set of disjoint sub clusters meets requirements of a given failover policy type behavior pattern and meets requirements of the group of supplemental data sets, verifying storage topology, that storage is connected so that partitions can access data from storage, where the storage is connected fully and/or pairwise and so that the storage topology does not contradict given failover node sequences, and specifying a failover node sequence for the policy solution for each partition; wherein the second set of sub operations includes receiving a second signal from a user system specifying a plurality of supplemental data sets, and combining the failover policy behavior patterns with the supplemental data sets, including creating failover node sequences for the unique policy solution by performing the first set of sub operations; wherein combining the failover policy type behavior patterns with a group of supplemental data sets includes performing a third group of sub operations comprising creating the failover node sequence specified from the plurality of failover policy type behavior patterns using an algorithm that acts on each sub cluster independently; and wherein the algorithm specifying failover node sequences takes a policy specification, a list of nodes and a list of partitions in the database sub cluster configuration, and a set of supplementary data as arguments in specifying said failover node sequences.

2. The method according to claim 1, wherein the plurality of failover policy type behavior patterns are restricted when an interactive configuration graphical user interface is used to implement the receipt of the first signal from the user system specifying one of a plurality of failover policy type behavior patterns.

3. The method according to claim 1, automatically generating an update unique policy solution by overwriting any failover node sequences that changed, when a new node is added to the cluster.

4. The method according to claim 1, further comprising adding weights for each partition's resource group when a number of resource groups on a node exceeds a number of nodes available to host each partition's resource group after failover, wherein the failover node sequence is changed to equalize the stun of the weights of resource groups that are sent to each other node.

5. A system generating, by a database cluster management system, a plurality of database cluster failover policy availability configuration modeling solutions in a network of a plurality of computer systems, the system comprising:
a computer processor containing a plurality of units including a program unit, and at least one algorithm unit, at least one input device, and at least one output device, wherein the computer processor is cooperatively coupled to a plurality of network computers, and network storage devices over a network;
a computer executable program residing in the program unit, wherein the computer executable program when executed by the computer processor causes the computer processor to:
receive a first signal from a user computer system specifying one of a plurality of failover policy type behavior patterns causing the database cluster management computer system to provide a plurality of database cluster failover policy availability configuration modeling solutions solving database cluster availability requirements in the network of the plurality of computer systems, wherein the plurality of failover policy type behavior patterns includes a round robin policy type behavior pattern, a mutual policy type behavior pattern, an idle policy type behavior pattern, a distributed policy type behavior pattern and a custom policy type behavior pattern; and
determine one of whether generating policy type behavior patterns requires supplemental data sets and whether generating policy type behavior patterns requires no supplemental data sets; wherein, when generating policy type behavior patterns requires no supplemental data sets, then generating a policy general solution including performing a first set of sub operations, displaying an entire database cluster configuration modeling solution for the policy general solution, transmitting the entire database cluster configuration modeling solution for the policy general solution, and performing one of returning and ending; wherein generating policy type behavior patterns requires supplemental data sets, then generating a unique policy solution including performing a second set of sub operations, returning to the operation of generating the policy general solution including performing the first set of sub operations, displaying the entire database cluster configuration modeling solution for the unique policy solution, transmitting the entire database cluster configuration modeling solution for the unique policy solution, and performing one of returning and ending; wherein the first set of sub operations includes identifying a set of disjoint sub clusters by matching partition and node type tags; validating that a number of nodes in each sub cluster of the set of disjoint sub clusters meets requirements of a given failover policy type behavior pattern and meets requirements of the group of supplemental data sets, verifying storage topology, that storage is connected so that partitions can access data from storage, where the storage is connected fully and/or pairwise and so that the storage topology does not contradict given failover node sequences, and specifying a failover node sequence for the policy general solution for each partition; wherein the second set of sub operations includes receiving a second signal from a user system specifying one of a plurality of supplemental data sets, and combining the failover policy behavior patterns with the supplemental data sets, including creating failover node sequences for the unique policy solution by performing the first set of sub operations; and wherein combining the failover policy type behavior patterns with a group of supplemental data sets includes performing a third group of sub operations comprising creating the failover node sequence specified form the plurality of failover policy type behavior patterns using an algorithm that acts on each sub cluster independently; and wherein the algorithm specifying failover node sequences takes a policy specification a list of nodes and a list of partitions in the database sub cluster configuration and a set of supplementary data as arguments in specifying said failover node sequences.

6. The system according to claim 5, further comprising an interactive configuration graphical user interface, wherein the plurality of failover policy type behavior patterns are restricted when the interactive configuration graphical user interface is actuated provides the first signal received from the user system specifying one of a plurality of failover policy type behavior patterns.

7. The system according to claim 5, wherein the computer executable program when executed by the computer processor causes the database cluster management system to automatically generate an update unique policy solution by overwriting any failover node sequences that change state, when a new node is added to the cluster.

8. The system according to claim 5, wherein the computer executable program when executed by the computer processor causes the database cluster management system to add weighted values, when creating failover node sequences for the distributed failover policy behavior patterns, to each partition's resource group when a number of resource groups on a node exceeds a number of nodes available to host each partition's resource group after failover, and wherein the failover node sequence changes state to equalize the sum of the weights of resource groups that are sent to each other node.
